(19) United States
(12) Patent Application Publication
(10) Pub. No.: US 2006/0217096 A1
(43) Pub. Date: Sep. 28, 2006

(54) Testing apparatus for digital telecommunication

(76) Inventor: David Le Goff, TINTENIAC (FR)

Correspondence Address: PHILIPS INTELLECTUAL PROPERTY & STANDARDS, P.O. BOX 3001, BRIARCLIFF MANOR, NY, 10510, US

(21) Appl. No.: 10/548,720

(22) PCT Filed: Mar. 5, 2004
(86) PCT No.: PCT/IB04/00681

§ 371 Date: Sep. 8, 2005

(30) Foreign Application Priority Data
Mar. 13, 2003 (EP) 03290633.1

(51) Int. Cl. H04B 17/00

(52) U.S. Cl. 455/226.1; 455/161.1

(57) ABSTRACT

The invention relates to a testing apparatus (21) comprising means for receiving signals in a frequency range comprising a plurality of channels. The testing apparatus further comprises means for scanning said frequency range (210, 213), means for detecting at least one channel comprising a digital signal (211), means for measuring a bit error rate of said digital signal (212), means for performing at least one comparison between said bit error rate and at least one threshold (213), and means for determining a quality of said channel on the basis of said comparison.

### FIELD OF THE INVENTION

The present invention relates to a testing apparatus for digital telecommunication.

The present invention also relates to a method of determining a quality of at least one channel in a digital telecommunication and a computer program for implementing this method.

The present invention also relates to a telecommunication network comprising such a testing apparatus.

The present invention is particularly relevant for a testing apparatus for digital terrestrial television, such as a testing apparatus for DVB-T (DVB-T stands for Digital Video Broadcasting-Terrestrial).

### BACKGROUND OF THE INVENTION

In digital telecommunications, digital signals are sent by emitters and received by a user, for example by means of an antenna. It is often useful to know the quality of the received digital signals. For example, the quality of the received signals can be used in order to orientate the antenna adequately. Moreover, if the digital signal represents an audiovisual content, it might be useful for the user to know the quality of the received signal before buying an expensive television set.

The testing apparatus sent by Promax under reference “Prodig-2” allows determining the quality of analogue signals and Digital Terrestrial TV signals compliant with the DVB-T standard. This testing apparatus receives signals in a frequency range comprising a plurality of channels. For each channel, this testing apparatus measures the level or the channel power as well as the carrier above noise ratio C/N. An indication that the quality of a channel is good is displayed if the level or power is between recommended margins and the ratio C/N is greater than the minimum recommended value.

However, the power and the C/N ratio of a digital signal do not always guarantee that the quality of the digital signal is good. Actually, echo can be present in the digital signal, due to reflections of the signal before reaching the antenna. In this case, a multipath channel is obtained, which comprises a plurality of similar digital signals received at different times on the antenna. If these differences in times are larger than the guard interval defined for DVB-T, the quality of the audiovisual content may be bad. However, in this case, the power is between recommended margins and the ratio C/N is greater than the minimum recommended value. Moreover, the same channels can be used in adjacent areas for analogue and digital signals. If the analogue and digital signals are received on the same antenna, the quality of the audiovisual content may be bad. However, in this case, the power is also between recommended margins and the ratio C/N is greater than the minimum recommended value.

### SUMMARY OF THE INVENTION

It is an object of the invention to provide a testing apparatus in which the determination of the quality of the received digital signals is improved.

To this end, the invention proposes a testing apparatus comprising means for receiving signals in a frequency range comprising a plurality of channels, means for scanning said frequency range, means for detecting at least one channel comprising a digital signal, means for measuring a bit error rate of said digital signal, means for performing at least one comparison between said bit error rate and at least one threshold, and means for determining a quality of said channel on the basis of said comparison.

According to the invention, the determination of the quality of a channel comprising a digital signal is based on a bit error rate of this digital signal. As a consequence, this determination is improved, because the quality of a digital signal directly depends on the detected bit error rate.

In a preferred embodiment, the testing apparatus further comprises means for measuring a number of uncorrectable packets in the digital signal, said quality being further determined on the basis of said number. This leads to a further improvement in the determination of the quality of the digital signal. Actually, the bit error rate is measured during a relatively long time so that the comparison between said bit error rate and the threshold can lead to a good quality of the channel, whereas the digital signal comprises burst errors which are not corrected and which in fact deteriorate the resulting signal. Taking into account these uncorrectable errors thus improves the determination of the quality of the digital signal.

In an advantageous embodiment of the invention, the testing apparatus comprises means for detecting all the channels comprising a digital signal in the frequency range and means for determining the number of channels having a predetermined quality.

According to this advantageous embodiment, the testing apparatus can provide an indication of the number of channels comprising a digital signal, which have, for example, a good quality. This indication is obtained without need for a user to test each channel one after the other. As a consequence, a very easy to use testing apparatus is provided. Moreover, if the frequency range as well as the thresholds are predetermined in the testing apparatus, the testing apparatus is even easier to use. Actually, a user can know the number of channels he receives with a good quality, simply by connecting the output of his antenna up with the testing apparatus.

The invention also relates to a method of determining a quality of at least one channel comprising a digital signal in a frequency range comprising a plurality of channels, said method comprising a step of scanning said frequency range, a step of detecting at least one channel comprising a digital signal, a step of measuring a bit error rate of said digital signal, a step of performing at least one comparison between said bit error rate and at least one threshold, and a step of determining a quality of said channel on the basis of said comparison.

Advantageously this method comprises a step of detecting all the channels comprising a digital signal in the frequency range and a step of determining the number of channels having a predetermined quality.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1a diagrammatically illustrates a frequency range comprising a plurality of channels and FIG. 1b illustrates a detailed view of three channels of FIG. 1a;

FIG. 2 is a block diagram illustrating a testing apparatus in accordance with the invention;

FIG. 3 is a block diagram illustrating the digital error corrector of FIG. 2;

FIG. 4 illustrates a method of determining a number of channels in accordance with an advantageous embodiment of the invention.

### DETAILED DESCRIPTION OF THE INVENTION

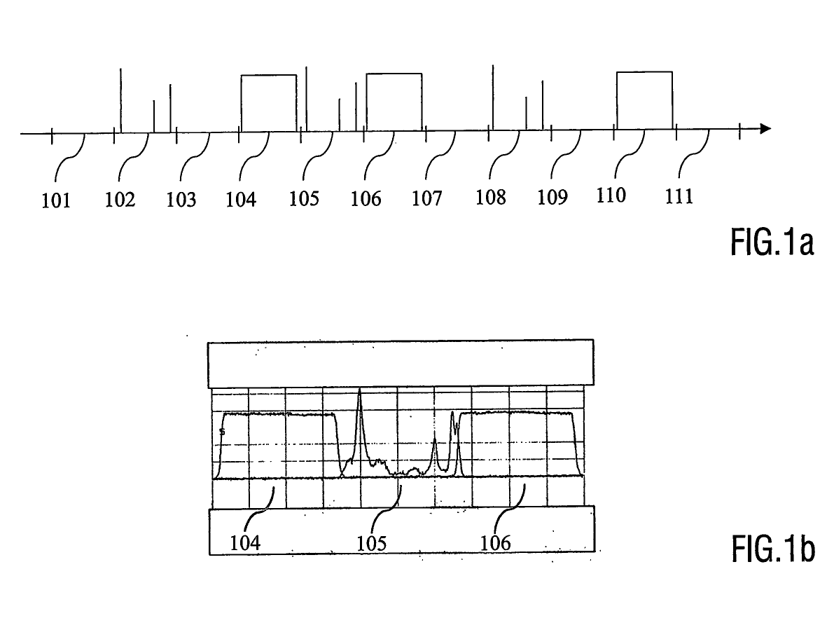

A frequency range comprising a plurality of channels is depicted on FIG. 1a. In this example, the frequency range comprises eleven channels 101 to 111. The invention can be applied to signals in a frequency range comprising a different number of channels. Actually, even for the same standard, such as the DVB-T standard, the number of channels differs from one geographical area to another. For example, in France, the DVB-T signals are broadcasted on the band 3 of the VHF frequency range (VHF stands for Very High Frequency), which is comprised between 174 and 223 Megahertz, and on the band 4 and 5 of the UHF frequency range (UHF stands for Ultra High Frequency), which are comprised between 470 and 862 Megahertz. The width of a channel might also differ depending on the technology and the geographical area. For example, in France, the length of a channel used for DVB-T is 8 Megahertz, but other countries can choose 6 or 7 Megahertz.

As a consequence, it is important to notice that the invention can be applied to a plurality of signals, as soon as these signals are comprised in a frequency range comprising channels having a predetermined width. For example, the invention might be applied to DAB signals (DAB stands for Digital Audio Broadcasting), ATSC signals used for digital television in USA (ATSC stands for Advanced Television System Committee), or ISDB-T signals used for digital television in Japan (ISDB-T stands for Integrated Services Digital Broadcasting—Terrestrial). However, the invention cannot be applied to satellite television using the DVB-S standard (DVB-S stands for Digital Video Broadcasting-Satellite), because the signals broadcasted by means of satellite are in a frequency range which does not comprise channels.

The following description applies to television signals, in particular to digital video signals using the standard DVB-T.

In the example of FIG. 1a, the illustrated frequency range comprises eleven channels 101 to 111. The first channel 101 does not comprise any signal. The second channel 102 comprises an analogue television signal. The third channel 103 does not comprise any signal. The fourth channel 104 comprises a digital television signal. Such a digital television signal is called a multiplex in DVB-T. The fifth channel 105 comprises an analogue signal, and so on. In FIG. 1a, the signals are diagrammatically illustrated. FIG. 1b gives a detailed view of measured signals corresponding to the fourth, fifth and sixth channels 104 to 106 of FIG. 1a.

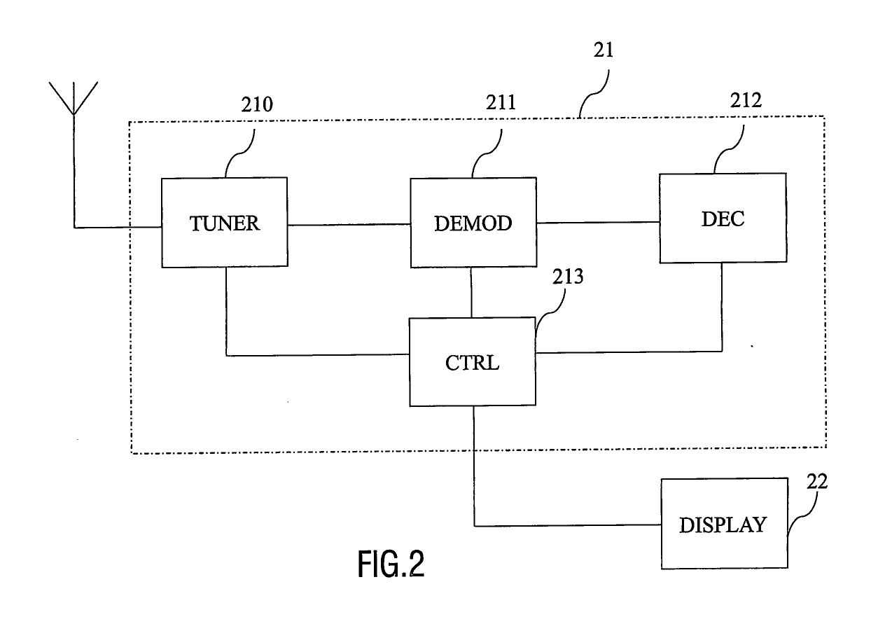

A testing apparatus in accordance with the invention is depicted on FIG. 2. Such a testing apparatus 21 comprises a tuner 210, a demodulator 211, a digital error corrector 212 and a controller 213. The testing apparatus 21 is intended to receive signals in a frequency range comprising channels. For example, the testing apparatus receives signals from an antenna, by means of receiving means, such as a socket connected up with the output of the antenna. In the following description, the received signals are the signals depicted in FIG. 1a.

When the testing apparatus 21 receives signals, it scans the frequency range of the signals in order to find a multiplex, i.e. a digital signal. The frequency range to scan can be predefined in the testing apparatus 21. For example, the frequency range can be the range 174-862 Megahertz in a testing apparatus for DVB-T intended to be used in France. The frequency range can also be determined by a user by means of an interface, or by any means, such as a software application in the controller 213. In order to scan the frequency range channel by channel, the testing apparatus 21 has also to know the width of a channel. This width can also be predefined in the testing apparatus 21, for example 8 Megahertz in a testing apparatus for DVB-T intended to be used in France, or can also be determined by a user by means of an interface, or by any means, such as a software application in the controller 213.

In the example of FIG. 1a, the controller 213 knows that the testing apparatus 21 has to scan the eleven channels 101 to 111. First, the controller 213 sends an order to the tuner 210, so that the tuner 210 converts the signal received at a frequency corresponding to a central frequency of the first channel 101, into a signal at an intermediate frequency, which is the output frequency of the tuner 210. The central frequency of the first channel 101 can be determined easily, as the controller 213 knows the low frequency of the first channel 101, as well as the width of the first channel 101.

Then, the signal at the output of the tuner 210 is demodulated by the demodulator 211. In this example, there is no signal on the first channel 101, so that the demodulator 211 cannot demodulate the signal at the output of the tuner 210. In this case, the demodulator 211 indicates to the controller 213 that there is no demodulated signal.

Then, the controller 213 sends an order to the tuner 210, so that the tuner 210 converts the signal received at a central frequency of the second channel 102, into a signal at the intermediate frequency. The central frequency of the second channel 102 can easily be determined, by adding the width of a channel to the central frequency of the first channel 101. As the signal on the second channel 102 is analogue, the demodulator 211 cannot demodulate the signal at the output of the tuner 210 and thus indicates to the controller 213 that there is no demodulated signal.

Then, the controller 213 sends an order to the tuner 210, so that the tuner 210 converts the signal received at a central frequency of the third channel 103, into a signal at the intermediate frequency. As there is no signal on the third channel 103, the demodulator 211 indicates to the controller 213 that there is no demodulated signal.

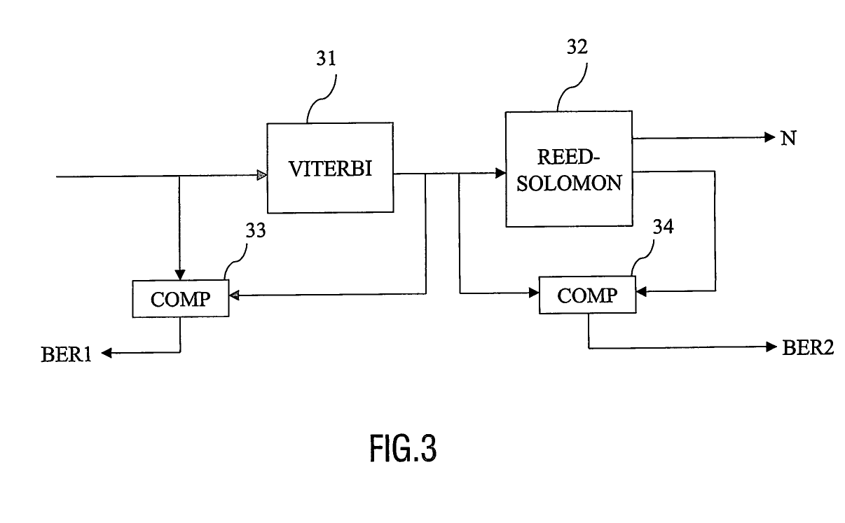

Then, the controller 214 sends an order to the tuner 210, so that the tuner 210 converts the signal received at a central frequency of the fourth channel 104, into a signal at the intermediate frequency. As the fourth channel 104 comprises a multiplex, the corresponding digital signal is demodulated by the demodulator 211, which indicates to the controller that there is a multiplex on the fourth channel 104. The demodulated signal is sent to the digital error corrector 212, which determines a bit error rate of the digital signal on the fourth channel 104. The digital error corrector will be described in more details on FIG. 3.

The bit error rate is sent to the controller 213, which compares this bit error rate with a threshold. If the bit error rate is greater than this threshold, the controller 213 determines that the quality of the multiplex on the channel 104 is bad. If the bit error rate is lower than the threshold, the controller 213 determines that the quality of the multiplex on the channel 104 is good.

Examples of thresholds which might be used in the testing apparatus 21 are 10-4 or 2.10-4. It is important to notice that a plurality of thresholds can be used in the testing apparatus 21. For example, a first and a second threshold can be used, leading to three different level of quality, the first threshold being greater than the second threshold. If the bit error rate is greater than the first threshold, the controller 213 determines that the quality of the multiplex is bad. If the bit error rate is lower than the second threshold, the controller 213 determines that the quality of the multiplex is good. If the bit error rate is between the first and second threshold, the controller 213 determines that the quality of the multiplex is medium.

The quality of the multiplex on the fourth channel 104 is then displayed on a display 22. This display 22 can be part of the testing apparatus 21, or can be a separate display. In addition to the quality of the fourth channel 104, the display 22 can display further information, such as a name of the multiplex, or the names of the channels comprised in this multiplex. Actually, this information is transmitted with the multiplex and demodulated, so that the controller 213 can have knowledge of this information and can order the display 22 to display it.

As a consequence, a very simple to interpret indication is displayed on the display 22, because the quality of the multiplex is directly displayed, eventually together with further information on the multiplex. Hence, a user of the testing apparatus 21 does not need any knowledge of the technology, because he immediately has access to the quality of the multiplex.

Then, the steps described hereinbefore are repeated, in order to find another multiplex in the frequency range. These steps can be repeated after a certain time during which the quality of the fourth channel 104 has been displayed, or after the user has required to find another multiplex, for example by pressing a key on an interface of the testing apparatus 21.

The demodulator 211 and the digital error corrector 212 are known from those skilled in the art. For example, the circuit sold by the applicant under reference TDA10046 comprises such a demodulator and such a digital error corrector.

FIG. 3 illustrates the digital error corrector 212 of FIG. 2. The digital error corrector 212 comprises a Viterbi corrector 31, a Reed-Solomon corrector 32, a first comparator 33 and a second comparator 34. The encoding of digital signals for DVB-T is specified in the standard ETSI EN 300 744. DVB-T signals comprise convolutional corrector codes and Reed-Solomon corrector codes, which are used in order to correct the received signal. DVB-T data are broadcasted by packets of 204 bytes, each packet comprising convolutional coding and a Reed-Solomon corrector code.

When the digital error corrector 212 of FIG. 2 receives a demodulated signal, a first correction is performed on the packets of this demodulated signal, by means of the Viterbi corrector 31. Then a second correction is performed on the corrected packets, by means of the Reed-Solomon corrector 32. A first bit error rate BER1 is measured, which results from a comparison between the demodulated signal and the corrected signal at the output of the Viterbi corrector 31. A second bit error rate BER2 is measured, which results from a comparison between the corrected signal at the output of the Viterbi corrector 31 and the corrected signal at the output of the Reed-Solomon corrector 32. The bit error rates are determined on a relatively long period of time, for example a few hundred milliseconds.

The first and second bit error rates BER1 and BER2 can be used by the controller 213 in order to determine the quality of the channel, by comparison with a threshold. However, it is preferable to use the second bit error rate BER2, which leads to a better determination of the quality of the channel.

The digital error corrector 212 can also determine the number N of uncorrectable packets, i.e. the number of packets which have not been corrected during this period of time. This number N of uncorrectable packets can be taken into account in order to determine the quality of the corresponding channel. Actually, it is possible that a few packets are not corrected during said period of time, because these packets each comprise more erroneous bytes than the Viterbi corrector 31 and the Reed-Solomon corrector 32 are able to correct. However, if the other packets have relatively few erroneous bytes, the second bit error rate BER2 is relatively low, because it is measured over a relatively long period. Hence, the controller 213 might determine that the quality of the channel is good, although there are uncorrectable packets, which deteriorate the quality of the resulting audiovisual content.

Taking into account the number N of uncorrectable packets thus improves the determination of the quality of the channels. For example, the controller 213 can determine that the quality of the channel is good if the bit error rate is lower than a threshold and there is no uncorrectable packets or a number of uncorrectable packets lower than another threshold, for example 2.

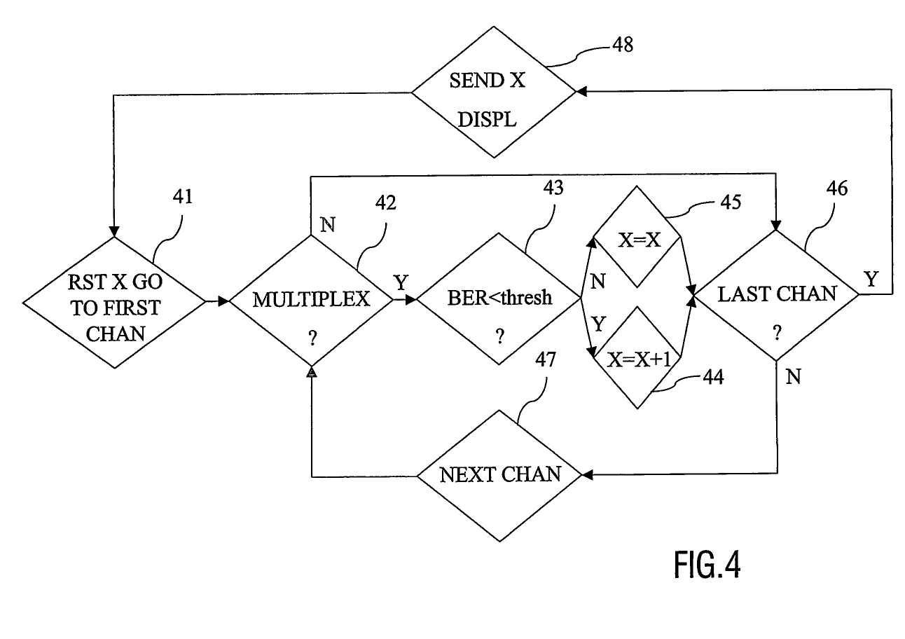

FIG. 4 illustrates a method of determining a number of channels in accordance with an advantageous embodiment of the invention. A goal of the advantageous embodiment of the invention is to determine the number of channels comprising a multiplex, which have a predetermined quality. The example described hereinafter applies to the case where only one threshold is used by the controller 213 in order to determine the quality of the channels, and the number of uncorrectable packets is not taken into account in order to determine the quality of the channels. Of course, this advantageous embodiment could be applied with a larger number of thresholds, i.e. a larger number of quality levels and by taking into account the number of uncorrectable packets for determining the quality of the channels. In the example described hereinafter, the method is used in order to determine the number X of channels having a good quality in a predetermined frequency range.

At step 41, the number X is set to zero and the controller 213 sends an order to the tuner 210, so that the tuner 210 converts the signal received at a frequency corresponding to a central frequency of the first channel of the frequency range, into a signal at an intermediate frequency. This signal is demodulated, and at step 42, it is determined if the channel comprises a multiplex or not. If yes, the bit error rate of the digital signal is measured and compared, at step 43, with a threshold. If the bit error rate of the digital signal is lower than the threshold, indicating that the quality of the channel is good, the number X is incremented at step 44. If the bit error rate of the digital signal is larger than the threshold, indicating that the quality of the channel is bad, the number X is not incremented at step 45. Then, it is checked, at step 46, if the channel which quality has been determined is the last channel in the frequency range or not. If, at step 42, the channel does not comprise any multiplex, next step is step 46, where it is checked if the channel is the last channel in the frequency range.

If the processed channel is not the last channel, the controller 213, at step 47, sends an order to the tuner 210, so that the tuner 210 converts the signal received at a frequency corresponding to a central frequency of the next channel in the frequency range into a signal at an intermediate frequency. Then it is checked, at step 42, if the next channel comprises a multiplex, and so on.

If the processed channel is the last channel at step 46, then the number X corresponds to the number of channels in the frequency range having a good quality. This number can then be sent, at step 48, to the display 22 in order to be displayed. Then step 41 is performed, and a new determination of the number of channels having a good quality is performed. It is advantageous to perform consecutive determinations of the number of channels having a good quality. Actually, when one wants to orientate an antenna in order to obtain a large number of multiplexes having a good quality, the number of multiplexes having a good quality can depend on the orientation of the antenna. Having consecutive measures allows finding the best orientation for the antenna.

As a consequence, this embodiment of the invention is particularly advantageous, because it allows rapidly obtaining the number of multiplexes which are received with a good quality. Actually, such a determination takes a few second, generally less than ten seconds. Moreover, such a determination is particularly easy, as it requires only connecting the output of the antenna up with the testing apparatus, in case where the frequency range, the thresholds and the channel width are predetermined in the testing apparatus. Hence, a user can know the number of multiplexes he receives, without any knowledge of the technology.

The display 22 can be, for example, a set of LEDs, a switched on LED corresponding to a channel having a good quality. In the case where more than two levels of quality are defined, the display 22 comprises more than one set of LEDs.

The display 22 can also be a liquid crystal display. In this case, additional information can be displayed on the display 22. Actually, the display 22 can also display the names of the multiplexes having a good quality, or the names of the channels of these multiplexes. In order to achieve this, the method described on FIG. 4 further comprises a step of storing information related to the multiplexes having a good quality.

An apparatus in accordance with the invention can be part of a telecommunication network comprising at least an emitter for sending signals, a transmission channel and a receptor for receiving said signals

The method of determining a quality of at least one channel comprising a digital signal in a frequency range comprising a plurality of channels according to the invention might be implemented in an integrated circuit, which is intended to be integrated in a testing apparatus. A set of instructions that is loaded into a program memory causes the integrated circuit to carry out the method. The set of instructions may be stored on a data carrier such as, for example, a disk. The set of instructions can be read from the data carrier so as to load it into the program memory of the integrated circuit, which will then fulfil its role.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A testing apparatus (21) comprising means for receiving signals in a frequency range comprising a plurality of channels (101-111), means for scanning said frequency range (210, 213), means for detecting at least one channel comprising a digital signal (211), means for measuring a bit error rate of said digital signal (212), means for performing at least one comparison between said bit error rate and at least one threshold (213), and means for determining a quality of said channel on the basis of said comparison.

2. A testing apparatus as claimed in claim 1, said apparatus further comprising means for measuring a number of uncorrectable packets in the digital signal, said quality being further determined on the basis of said number.

3. A testing apparatus as claimed in claim 1, said apparatus comprising means for detecting all the channels comprising a digital signal in the frequency range and means for determining the number of channels having a predetermined quality.

4. A method of determining a quality of at least one channel comprising a digital signal in a frequency range comprising a plurality of channels, said method comprising a step of scanning said frequency range, a step of detecting at least one channel comprising a digital signal, a step of measuring a bit error rate of said digital signal, a step of performing at least one comparison between said bit error rate and at least one threshold, and a step of determining a quality of said channel on the basis of said comparison.

5. A method as claimed in claim 4, said method further comprising a step of measuring a number of uncorrectable packets in the digital signal, said quality being further determined on the basis of said number.

6. A method as claimed in claim 4, said method comprising a step of detecting all the channels comprising a digital signal in the frequency range and a step of determining the number of channels having a predetermined quality.

7. A computer program comprising a set of instructions which, when loaded into a processor or a computer, causes the processor or the computer to carry out the method as claimed in claim 1.

8. A telecommunication network comprising at least an emitter for sending signals, a transmission channel, a receptor for receiving said signals and a testing apparatus as claimed in claim 1.
